(19) United States
(12) Patent Application Publication
(10) Pub. No.: US 2018/0165670 A1
(43) Pub. Date: Jun. 14, 2018

(54) HANDS-FREE SHOPPING APPLICATIONS INCLUDING SCANNING FUNCTIONS

(71) Applicant: Wal-Mart Stores, Inc., Bentonville, AR (US)

(72) Inventor: Yurgis Mauro Bacallao, Centerton, AR (US)

(21) Appl. No.: 15/840,398

(22) Filed: Dec. 13, 2017

Related U.S. Application Data
(60) Provisional application No. 62/433,975, filed on Dec. 14, 2016.

(51) Int. Cl. G06Q 20/20; G06Q 30/06

(52) U.S. Cl. CPC G06Q 20/208; G06Q 20/3276; G06Q 30/0633

(57) ABSTRACT

A hands-free scanning system comprises an application stored at and executed by a personal mobile computing device. The application is configured to perform a commercial function related to a purchase at a retail store. A retail store mobile computing device includes a display screen. The personal mobile computing device application and the mobile computing device form an electronic pairing for exchanging data therebetween in order to perform the commercial function. A store computer system exchanges data with the personal mobile computing device for performing the commercial function. The retail store mobile computing device displays a result of the commercial function in response to the retail store mobile computing device receiving the exchanged data and outputting the result from the exchanged data via the electronic pairing.

### RELATED APPLICATIONS

This application claims the benefit of U.S. Provisional Patent Application No. 62/433,975 filed on Dec. 14, 2016 entitled “Hands-Free Shopping Applications Including Scanning Functions,” the content of which is incorporated herein by reference in its entirety.

### TECHNICAL FIELD

The present inventive concepts relate generally to techniques for purchasing items during a shopping experience, and more specifically, to systems and methods that provide an electronic exchange of data between mobile devices and store computers.

### BACKGROUND

A typical shopping experience entails a store customer using a shopping cart or basket to collect items from various regions of the store, then proceed to a checkout counter where the items are purchased.

### SUMMARY

In one aspect, provided is a hands-free scanning system, comprising: a shopping application stored at and executed by a personal mobile computing device, the application configured to perform a commercial function related to a purchase at a retail store; a retail store mobile computing device including a display screen, wherein the personal mobile computing device application and the mobile computing device form an electronic pairing for exchanging data therebetween in order to perform the commercial function, wherein the retail store mobile computing device performs a scanning operation as a first operation of the commercial function, and the shopping application facilitates a communication with a store computer system as a second operation of the commercial function in response to the first operation; and the store computer system that exchanges data with the personal mobile computing device for performing the commercial function, wherein the retail store mobile computing device displays a result of the commercial function in response to the retail store mobile computing device receiving the exchanged data and outputting the result from the exchanged data via the electronic pairing.

In some embodiments, the retail store mobile computing device is coupled to or integrated with a shopping cart or basket.

In some embodiments, the system further comprises at least one sensor that detects when store items are placed in the shopping cart or basket, and the shopping application tracks via the electronic pairing the presence of the items in the shopping cart or basket for automatically performing a point of sale operation.

In some embodiments, the display screen of the retail store mobile computer displays an identifying marker, and wherein the electronic pairing is formed in response to the personal mobile computing device scanning and processing the identifying marker. In some embodiments, the identifying marker includes a quick response (QR) code.

In some embodiments, the system further comprises a media sharing technology to form the electronic pairing. In some embodiments, the media sharing technology includes a Bluetooth™ interface.

In some embodiments, the second operation of the commercial function includes at least one of generating a shopping list, selecting items for purchase at the store, retrieving data regarding items of interest, and purchasing the items.

In some embodiments, the commercial function includes a processing of store advertisements, coupons, or discounts, wherein the first operation performed by the retail store mobile computing device includes a scan operation of the store advertisements, coupons, or discounts, and in response, the personal mobile computing device application outputs a result of the scan operation to the store computer system for processing.

In some embodiments, the electronic pairing is performed at the beginning of the shopping process, the retail store mobile computing device initiates the commercial function after the electronic pairing, and the personal mobile computing device application tracks activity of the retail store mobile computing device when performing the commercial function.

In some embodiments, the personal mobile computing device application is used to control shopping functions performed electronically, including point of sale operations performed at the end of a shopping activity, in response to the commercial function performed by the retail store mobile computing device.

In some embodiments, after the pairing, the electronic pairing permits the shopper to pay for store items from the retail store mobile computing device.

In some embodiments, the store device performs a point of sale (POS) function from the shopping cart.

In some embodiments, the scanning system communicates with a store security system to generate an alarm if the customer attempts to leave the store without paying for the items retrieved as part of the commercial function.

In some embodiments, the pairing is an active pairing or a passive pairing.

In some embodiments, the active pairing occurs when the customer's mobile device is used in the store to perform a scanning operation when away from the shopping cart.

In some embodiments, the passive pairing occurs when the mobile device is placed in the customer's pocket after initial connection and used for communicating with a peripheral device at the shopping cart which performs the scanning.

In some embodiments, the customer mobile computing device includes a battery that outputs a voltage that is less when paired with the store device than when performing the commercial function in the absence of the pairing.

In another aspect, provided is an electronic display that links with an application stored at and executed by a personal mobile computing device for scanning products at a shopping cart and tracking the scanned products at the personal mobile computing device, wherein a store customer uses the electronic display to complete a purchase of the scanned products via the linked personal mobile computing device with a remote point of sale (POS) system.

In some embodiments, the electronic display communicates with the personal mobile computing device in real-time via the application, such as a hands-free scanning system point of sale (POS) software application.

In some embodiments, the electronic display includes a liquid crystal display (LCD).

In another aspect, provided is a method for shopping, comprising: forming an electronic pairing between a personal mobile computing device and a retail store computing device; performing, by the retail store computing device, a peripheral operation during a shopping experience; and facilitating, by the personal mobile computing device via the electronic pairing, an exchange of a result produced during the peripheral operation from the retail store computing device and a remote store computer.

### BRIEF DESCRIPTION OF THE DRAWINGS

FIG. 1 is a diagram of an environment in which embodiments of a hands-free scanning system may be practiced.

FIG. 2 is a block diagram illustrating flow paths between elements of a hands-free scanning system, in accordance with some embodiments.

FIG. 3 is a flow diagram of a method for exchanging data related to a commercial shopping function, in accordance with some embodiments.

FIG. 4 is a flow diagram of a method for processing stock at a retail establishment, in accordance with some embodiments.

FIG. 5 is a block diagram illustrating flow paths between elements of a hands-free scanning system, in accordance with other embodiments.

FIG. 6 is a block diagram illustrating flow paths between elements of a hands-free scanning system, in accordance with some embodiments.

### DETAILED DESCRIPTION OF EMBODIMENTS

Conventional checkout systems require a store customer to complete purchases at the end of a particular shopping experience, typically at a store checkout region populated with counters, store associates, cash registers, and so on near the exit region of the store. During checkout, a store associate typically uses a barcode scanner to scan the items in the shopping cart or basket to identify the item and to determine a total price of the scanned items. The customer may produce coupons or other discounts to reduce the price of the items.

Some stores have implemented systems that permit store customers, or shoppers, to use a smartphone or the like as a scanning device, which can simplify and expedite the checkout process. However, the functionality of such systems are limited with respect to inventory, for example, they do not provide information to a customer regarding what is in stock and whether the store has available items of interest. Also, in cases where smartphones may be used, the shopper may have difficulty using the smartphone while navigating the shopping cart between store item locations.

In brief overview, a hands-free scanning system and method are provided that establishes an electronic communication or pairing between two mobile electronic devices so that shopping-related operations may be performed that capitalize on different features of the two mobile devices. In some embodiments, the system and method allow a shopper to use a store-supplied electronic device with a display and relevant peripheral devices to perform sensing-relating functions or peripheral operations such as optical scanning of item identifying markers such as barcodes or the like, but to rely on the shopper's personal smartphone, electronic tablet, or other personal computing device to perform more processor-intensive functions, or “heavy lifting,” by tracking purchases and other related functions that cannot be performed by the store-provided device, which may have a smaller or inefficient processor that would quickly drain the battery of the device if the same operation was to be performed on the store-provided device.

To achieve the foregoing, the shopper's personal computing device executes at least one application for performing shopping functions electronically. The store-provided device uses its peripheral devices such as a barcode scanner, camera, and so on for collecting data, for example, barcode data from a scanned item, which is output to the personal computing device via a pre-established “electronic pairing” or “linking” for processing, storing, and future use such as point of sale (POS) functions. In doing so, the store-supplied device can perform scanning functions or other operations related to a shopping experience on behalf of the shopper's personal computing device, and provides scanning results or the like as inputs to the shopping application executed at the shopper's personal computing device. Conversely, the shopper's personal computing device may retrieve relevant data from a store computer, such as item information, which is output via the electronic pairing to the store-provided display.

In one example, the shopper's personal computing device may store shopping lists, point-of-sale information, and/or other relevant data that may be used to purchase items in an e-commerce application. Here, the shopper can rely on the store-provided device to pay for store items or other commercial shopping functions from conveniently-located display on the shopping cart rather than a cumbersome entry of payment data to the shopper's personal computing device. Also, the shopper's personal computing device facilitates a data exchange between the store-supplied device and an external data source, for example, a cloud computing environment where POS operations or other data retrieval functions occur.

In other examples, the store-provided device can be used to scan coupons, paper advertisements, and the like, and the mobile electronic device can process the received data as well as communicate with a store computer to compute adjusted prices based on the scanned coupons or the like. Therefore, the shopper does not need to remove the personal mobile electronic device from a pocket, purse, or other location because the user interaction is performed at the store-provided device and the shopper's personal computing device exchanges any user interaction data that is received at the store-provided device with the store computer, POS system, and/or other remote electronic device that would otherwise interact with the shopper's personal computing device absent the presence of the remote computing device. Also, the shopper's personal computing device performs less processing since these respective energy-consuming functions are performed by the store-provided device and remote computing device facilitated by the personal computing device. Thus, the customer mobile computing device may include a battery that outputs a voltage that is less when paired with the store device than when performing the commercial function in the absence of the pairing.

In some embodiments, the personal mobile computing device application and the store-supplied mobile computing device form an electronic pairing at the beginning of a shopping process for exchanging data therebetween in order for the store-supplied mobile computing device to perform a commercial function, such as scanning item barcodes, quick response (QR) codes, or the like during the shopping process. The personal mobile computing device application may process data stored at the personal computing device that is part of an electronic shopping function, such as shopping lists, shopper account data, and so on. This data may also or alternatively be stored at the store computer. Processing functions, such as pricing calculations, item information retrieval, inventory information, account information, and so on may be stored and executed at the store computer. Thus, when a shopper exits the store, the foregoing is performed so that any items acquired by the shopper are purchased, i.e., transaction processed so that the customer's credit card, account, or the like is charged based on the data gathered by the store-provided device at the cart.

In some embodiments, the customer's personal mobile computing device, e.g., smartphone or the like, in concert with the store provided device is used to provide an electronic function performed during a shopping trip, for example, gathering information on items placed in a shopping cart to be purchased at the end of the shopping trip. In some embodiments, the customer's personal mobile computing device is a bring your own device (BYOD) which is configured to comply with the stores' information technology (IT) requirements, which provision the personal mobile device with applications that permit the use of the personal mobile device by a customer or store associate in a shopping environment. The store-supplied mobile computing device may be part of the shopping cart, for example, coupled to the frame or handlebar, and may be used to display data processed by the personal mobile computing device and/or remote store computer. This may include an electronic display screen and scanner for scanning store items of interest automatically after they are placed in the cart. The electronic display screen and scanner may be linked to the customer's personal mobile electronic device, e.g., smartphone and so on, so that the scanning results may be processed by the customer device, for example, communicating with a point of sale system for purchasing the scanned items. In this manner, the customer's smartphone may be stored away, for example, placed in the customer's pocket or purse during the shopping experience, while the store-supplied mobile computing device acts as a proxy for performing functions that would otherwise require the display of the customer's smartphone or other personal mobile computing device. In particular, the store-supplied mobile computing device performs a scanning function and/or other shopping-related function that is initiated or otherwise mimics functions of the customer's personal computing device when the customer enters the store. In some embodiments, the customer may receive an incentive, for example, coupon, store discount, gift card, or the like for permitting the personal mobile computing device to be used, for example, in BYOD applications, in connection with store-related operations.

As described above, the customer's personal mobile computing device and a store-provided electronic device can be paired, or linked, so that an electronic data exchange may be formed during a shopping experience while allowing the customer to performing shopping functions from the store-provided device rather than a personal smartphone or other personal mobile device. Thus, data entry may be performed at the store-provided device instead of the personal computing device during a shopping experience, for example, when paying for items at the end of the shopping experience, without the need for a store clerk at a conventional checkout register.

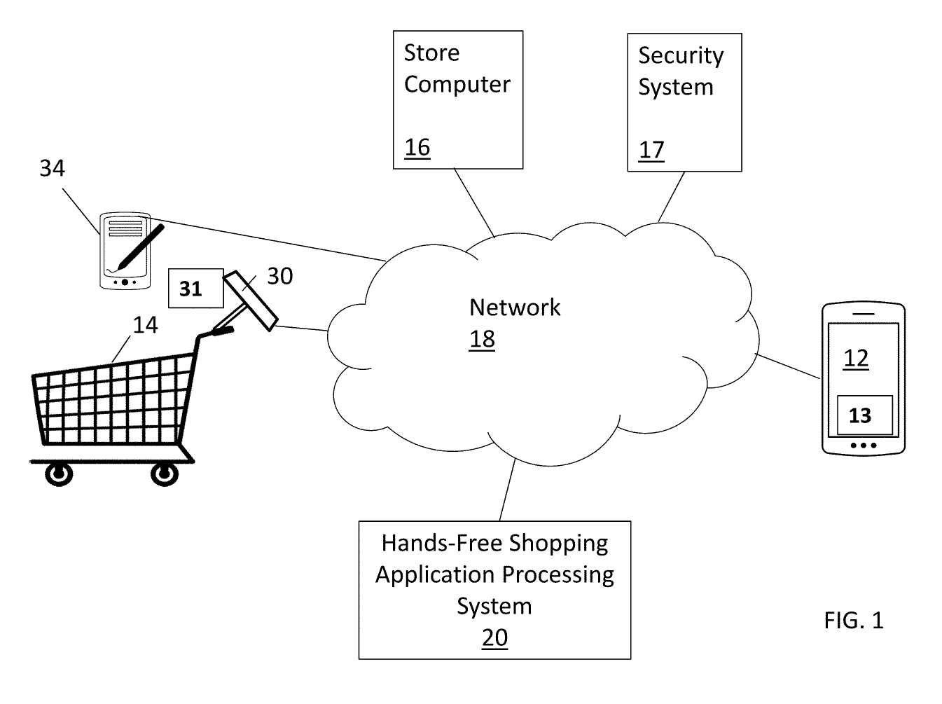

FIG. 1 is a diagram of an environment in which embodiments of a hands-free scanning system may be practiced.

The hands-free scanning system may include but not be limited to some or all of a hands-free shopping application 13 executed from a customer mobile electronic device 12, a retail store mobile computer display 30 attached to a shopping cart 14, a store-supplied mobile computing device 34, and a hands-free shopping application processing system 20. The hands-free scanning system also includes a point of sale application 31 that executes on the retail store mobile computer display 30 and/or store-supplied mobile computing device 34 for communicating with the customer mobile electronic device 12. The point of sale application 31 and/or hands-free shopping application 13 may be used to accept payment conditions or other payment functions. The customer mobile electronic device 12 may store and execute an application that communicates with the store-supplied device 34, which scans merchandise bar codes as the customer moves about the store, whereby the customer mobile electronic device 12 automatically receives and processes data regarding the scanned merchandise added to the shopping cart. In this example, the customer device 12 may also track the acquired merchandise, for example, keep a running total and itemized list of merchandise and prices, while also allowing the customer to checkout directly from the customer device 12.

The elements of the hands-free scanning system illustrated in FIG. 1 may be configured to operate in communication with other via a network 18 to perform one or more of the embodiments described in the brief overview above. The network 18 may include any electronic communication components and connections known to one of ordinary skill in the art, for example, a local area network (LAN), wide area network (WAN), Internet, WiFi, and so on.

The hands-free shopping application 13 may be executed on a store customer's personal computing device 12, such as a smartphone, electronic notebook or tablet, and so on, therefore permitting the customer to use the personal computing device 12 to shop at the store, or more specifically, to perform a commercial function related to a purchase at the store. However, the personal computing device 12 may perform processor-executed functions that are offloaded from or otherwise traditionally performed by a store computer, the store-provided computing device 34, and/or other electronic device. For example, the user can link a credit card or bank account to the application 13 so that the application 13 may process point-of-sale transactions instead of relying on a checkout counter point-of-sale register or the like. For example, a scanning device on the store-provided mobile device 34 may obviate or reduce the use of a conventional checkout register and scanning system. However, a feature of the inventive concept is that the user can place the personal computing device 12 including the shopping application 13 in the shopper's pocket, purse, or other location, and to use the store-provided computing device 34 and/or shopping cart computer display 30 instead of the customer's personal computing device 12 for performing scanning operations, for example, to purchase store items. Thus, the shopping application 13 stored and executed at the customer's personal computing device 12 operates with a store-provided scanner, camera, or other electronic sensors instead of or in addition to the personal computing device's peripheral hardware, such as the personal computing devices' camera.

In some embodiments, the hands-free shopping application 13 executed at the personal computing device 12 and communicating with a scanning application executed at the store customer personal computing device 12 permits the store customer personal computing device 12 to scan a barcode, QR code, or the like displayed on the store-supplied mobile computing device 34 to establish a link between the customer personal computing device 12 and the store-supplied mobile computing device 34. The link may include a Bluetooth™ communication or the like so that a direct exchange of data may be made between the devices at either end of the link. In other embodiments, the hands-free shopping application 13 combined with the scanning application permits the store customer personal computing device 12 to scan a barcode, QR code, or the like displayed on the retail store mobile computer display 30 to establish a link via the hands-free shopping application processing system 20 between the customer personal computing device 12 and/or the retail store mobile computer display 30.

For example, a hands-free application includes the coupling of the retail store mobile computer display 30 to a shopping cart so that the shopper does not need to physically insert data or read data from the customer personal computing device 12. The electronic pairing includes a secure connection for transaction processing, for example, where items are scanned by a scanning device in communication with the retail store mobile computer display 30, and the pairing permits the customer personal computing device 12 to communicate with a payment system. The secure connection is also linked to a customer account where customer and payment data may be retrieved and used in the payment process. This information may be stored at a cloud computer or other remote location.

The system is also constructed and arranged to accommodate a situation in which the link is broken between the customer personal computing device 12 and the store-supplied mobile computing device 34. This may occur, for example, when the shopper leaves the store with the customer personal computing device 12 so that the distance between the customer personal computing device 12 and the store-supplied mobile computing device 34 severs an existing pairing or otherwise prevents an electronic pairing from being established. A pairing must be re-established for the shopper to proceed with purchasing items at the store using the store-supplied mobile computing device 34. As described herein, a security system 17 may receive a notification when a pairing is broken and that store items identified during the pairing have not been purchased, which may be an indication that a shopper has left the store without paying for the items.

A store computer 16 may be connected to the network 18 for communicating with one or more elements of the hands-free scanning system. The store computer 16 may include but not be limited to a central computer and database that stores and executes store-related functions such as point of sale, coupon and discount management, customer information, customer service, and so on. Such data may be retrieved and processed by the customer personal computing device 12, the retail store mobile computer display 30, and/or the store-supplied mobile computing device 34. In some embodiments, some or all of the hands-free shopping application processing system 20 is part of, for example, store and executed at the store computer 16, more specifically, stored by at least one memory device of and executed by at least one hardware processor of the store computer 16. In some embodiments, some or all of the hands-free shopping application processing system 20 is part of a cloud computing environment. In other embodiments, some or all of the hands-free shopping application processing system 20 is part of, for example, store and executed at, the store-supplied mobile computing device 34. In other embodiments, some or all of the hands-free shopping application processing system 20 is part of, for example, stored and executed at, the retail store mobile computer display 30.

The security system 17 may be connected to the network 18 for communicating with one or more elements of the hands-free scanning system. The security system 17 is configured to generate an alarm and/or notify police or other authority if the customer attempts to leave the store without paying for the items retrieved as part of a commercial function, or otherwise attempts to acquire store items without paying for them. The security system 17 may generate notifications that are output to the customer device 12 regarding a need to pay or other related information.

Another application of the security system 17 may include a real time application and communication that eliminates the need for a store associate at a store exit confirming store purchases by checking receipts or other proof of purchase as customers leave the store. The security system 17 in concert with other elements of the hands-free scanning system may be configured to allow the customer to walk out of the store without generating an alarm or other security awareness, but may generate a notification at the personal computing device display reminding the customer to purchase store items scanned and acquired by the customer prior to leaving the store. The security system 17 may generate predetermined messages, which may be displayed depending on the customer location relative to the store exit. In instances where the customer does not pay for the items, for example, using a liquid crystal display (LCD) display 30 on the cart 14, the display 30 may present notifications, warnings, and/or alarms. The security system 17 may be configured to automatically establish a phone call or other communication connection with a local police department, security facility, or the like if the customer actually leaves the store without purchasing the items.

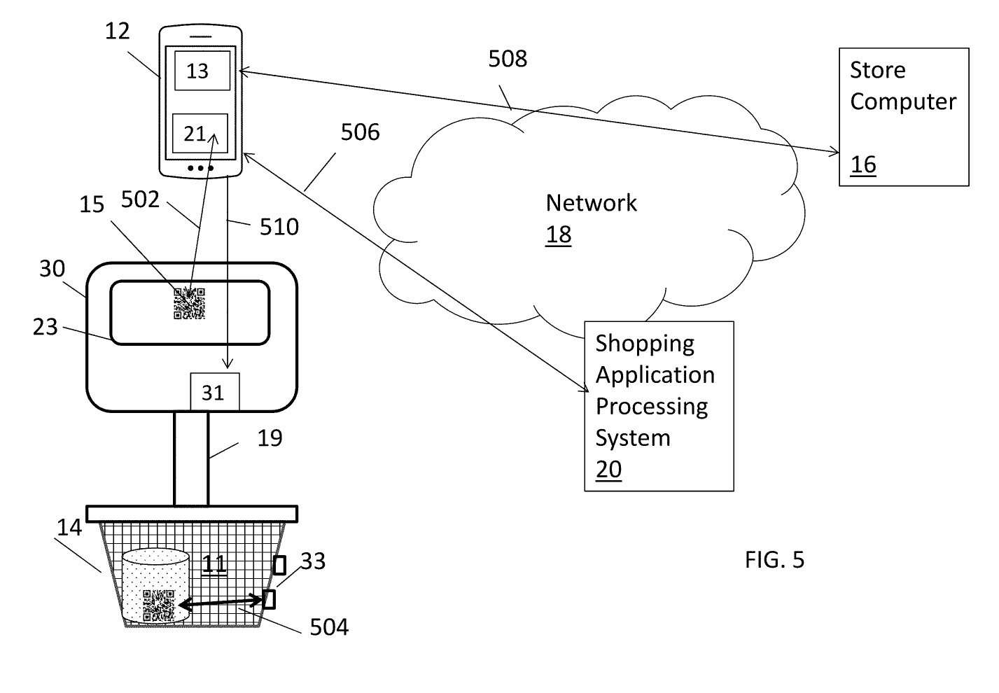

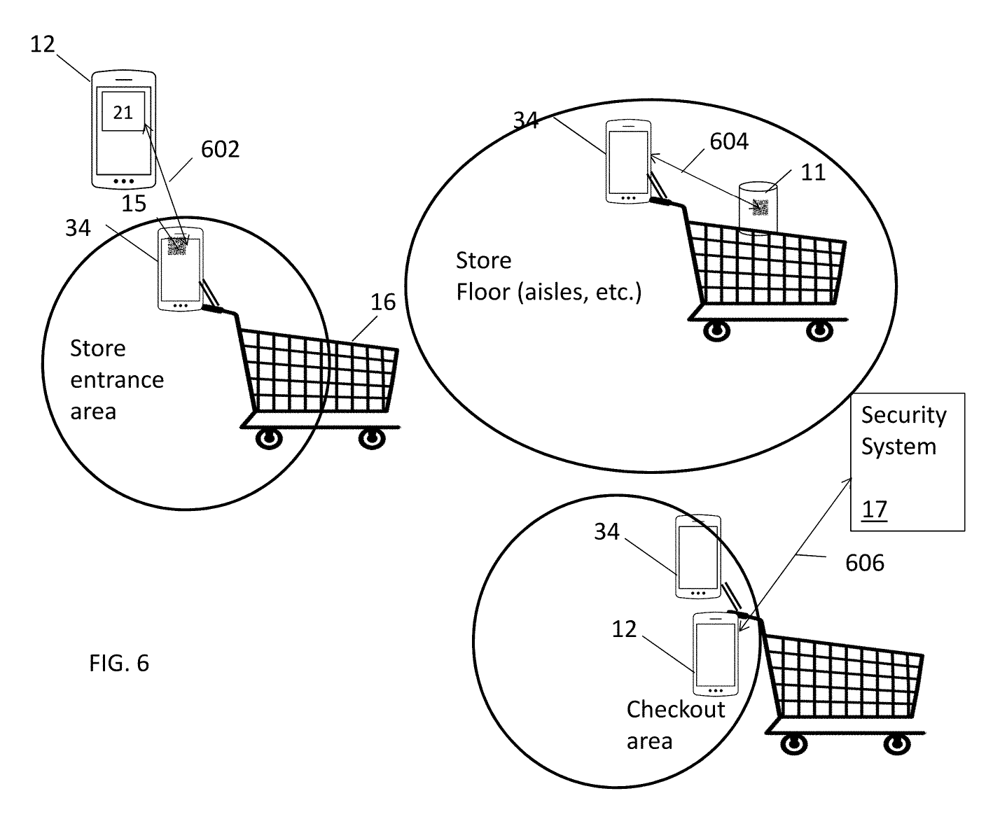

A formed electronic pairing between the customer personal computing device 12, the retail store mobile computer display 30, and/or the store-supplied mobile computing device 34 permits the store security system 17 to detect via the pairing when the shopper does not pay for an item, and can trigger an alarm or other security technique. For example, as shown in FIG. 6, a shopper entering the store, acquiring a cart or basket, and failing to pair the shopper's smartphone accessible to the store system but nevertheless attempting to scan items with the store-supplied device 34 or display 30 sans, or absent, the pairing may trigger an alarm via a signal output to the security system 17 indicating that the scanner of the store-supplied device 34 or display 30 is being used but there is no personal computing device 34 in electronic communication with the store security system 17. In a related example, the shopping cart or basket may be configured with sensors that detect when items are placed in the basket, for example, shown in FIG. 5, where the security system 17 is notified when there is no pairing at the time that the items are placed in the cart. In some embodiments, a message may be displayed at the store-supplied device 34 or display 30 in the event that the foregoing event occurs. Here, the shopper may be provided a notification, reminder, or the like that an electronic connection, or link or pairing, must be established prior to using the scanner. In other embodiments, the shopper may establish the electronic connection after all items for purchase have been scanned, where the shopper may be receive a notification that the pairing must be established to complete a POS transaction via the customer device 12.

The security system 17 may include a processor that generates a notification, phone call, or other communication when a predetermined criteria is met, for example, after a predetermined number of items having a combined value is exceeded.

In some embodiments, the communication between the hands-free shopping application processing system 20, the customer personal computing device 12, and the store-supplied mobile computing device 34 may be active or passive. For example, a link may be active if the customer smart system is used within the store to provide scanning solutions when away from the shopping cart. In another example, a link may be passive from the moment the customers pockets their smart device after initial connection, e.g., QR, Bluetooth, or other media sharing technology. This saves customer device batteries and processor usage as everything is performed as part of a background process.

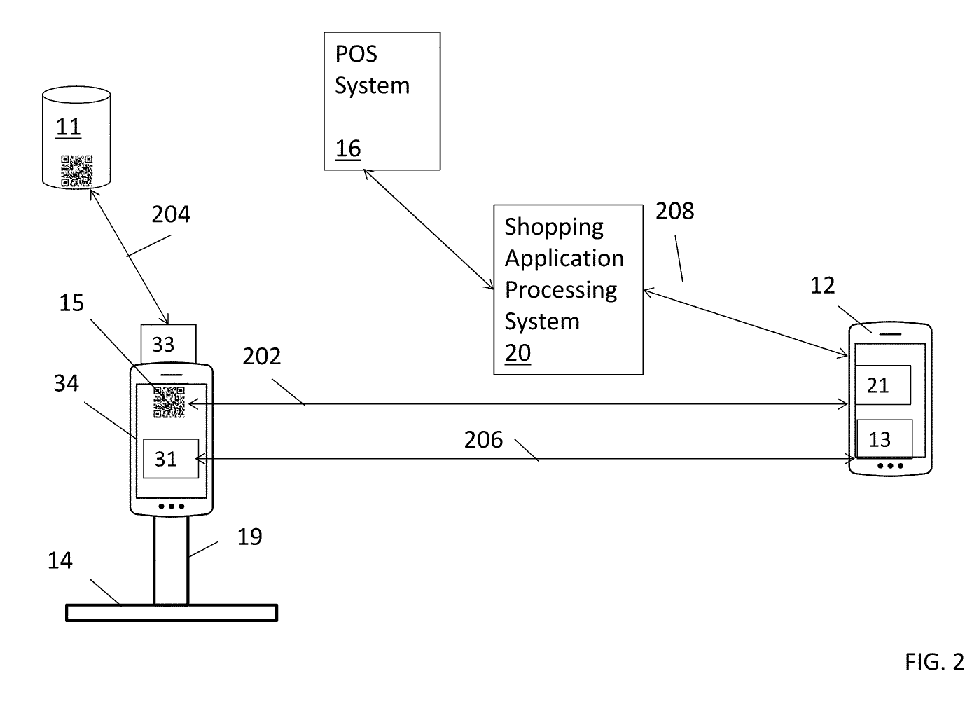

FIG. 2 is a block diagram illustrating flow paths between elements of a hands-free scanning system, in accordance with some embodiments. Although not shown, network 18 may be provided to establish the flow paths between the various elements.

At step 202, the scanning device 21 of a store customer personal computing device 12 scans a barcode 15, for example, a QR code, displayed at a store mobile computing device 34 by the point of sale application 31 executed at the store mobile computing device 34 to link the customer personal computing device 12 to the store-supplied mobile computing device 34 and cloud-computing device such as store computer 16.

At step 204, after the store mobile computing device 34 and store customer personal computing device 12 are linked, the store mobile computing device 34 may initiate a commercial function, for example, used to purchase a store item 11. Here, the store mobile computing device 34 includes a scanning device 33 for scanning a barcode, QR code, or other identifying marker on the item 11.

At step 206, a data exchange may be performed. For example, an informative message may be directed from the store mobile computing device 34 via the store customer personal computing device 12 and hands-free system 20 to POS system 16 regarding the scanned item 11. The store customer personal computing device 12 can track the scanned item 11 so that the item 11 is added to a list of items to be purchased at the POS system 16.

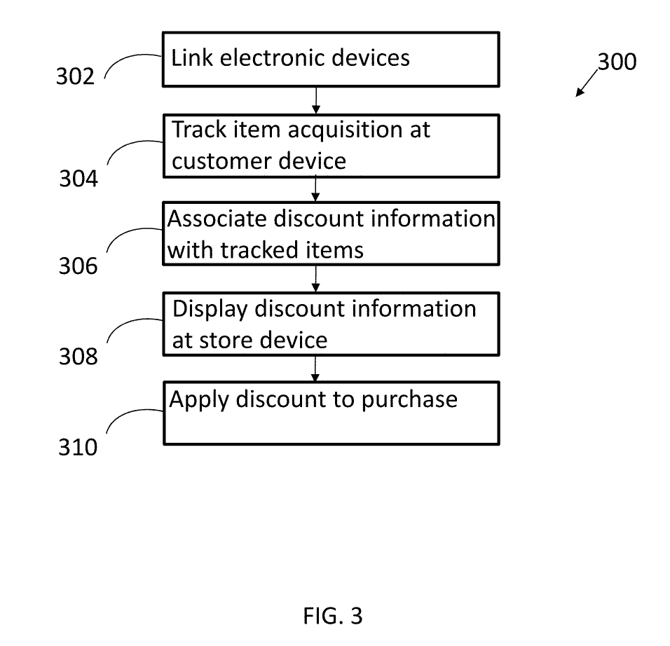

FIG. 3 is a flow diagram of a method 300 for exchanging data related to a commercial shopping function, in accordance with some embodiments. Some or all of the method 300 may be performed by the hands-free scanning system described with reference to FIGS. 1 and 2. Although the relationship between a store mobile computing device 34 and store customer personal computing device 12 is described, the retail store mobile computer display 30 may be used in addition to, or instead of the store mobile computing device 34.

At block 302, a store mobile computing device 34 and store customer personal computing device 12 are linked. A linked connection may be formed by the scanning device 21 of a store customer personal computing device 12 scanning a QR code 15 or other identifying marker displayed at a store mobile computing device 34. The QR code may include information regarding authentication, identification and so on to permit an electronic connection, link, or data path, to be formed.

At block 304, an item acquisition is tracked at the store customer personal computing device 12. For example, the hands-free scanning system can capture information regarding a customer planning to purchase an item of interest 11 at the store. For example, the system can include sensors or the like at or near the cart that can track when the customer picks up a grocery item and places the item(s) 11 in the grocery cart.

At block 306, the store computer 16 may associate discount information with the tracked item(s) 11.

At block 308, the discount information may be displayed at the store mobile computing device 34 and/or retail store mobile computer display 30.

At block 310, the discount is applied to the purchase, for example, by a calculation performed at the store computer 16, which outputs a result that includes the discounted price.

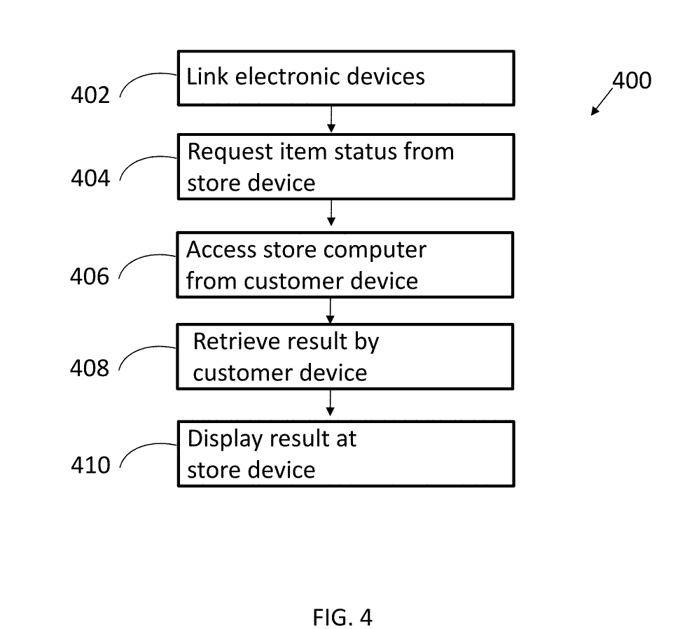

FIG. 4 is a flow diagram of a method 400 for processing stock at a retail establishment, in accordance with some embodiments. Some or all of the method 400 may be performed by the hands-free scanning system described with reference to FIGS. 1 and 2. Although the relationship between a store mobile computing device 34 and store customer personal computing device 12 is described, the retail store mobile computer display 30 may be used in addition to, or instead of the store mobile computing device 34.

At block 402, a store mobile computing device 34 and store customer personal computing device 12 are linked. A linked connection may be formed by the scanning device 21 of a store customer personal computing device 12 scanning a barcode 15 displayed at a store mobile computing device 34.

At block 404, the customer can enter a request electronically to the store mobile computing device 34, for example, by typing text, speech-to-text, and so on. A request may include a request for a particular stock item. In some embodiments, a camera or other sensor on the store mobile computing device 34 can be used to collect images or the like of the item of interest.

At block 406, the customer personal computing device 12 automatically accesses the store computer 16 to retrieve the requested information. In some embodiments, the image of the item provided by the store device may be used as part of the request, for example, a request whether the item is available in inventory. In some examples, a scanning device of the store-provided mobile device eliminates the problem of not knowing what's in stock and whether the store is carrying inventory levels of an item of interest.

At block 408, a result is retrieved by the customer personal computing device 12.

At block 410, the display 30 displays the result. In particular, the customer personal computing device 12 outputs the result for display.

FIG. 5 is a block diagram illustrating flow paths between elements of a hands-free scanning system, in accordance with other embodiments.

At step 502, the scanning device 21 of a store customer personal computing device 12 scans a barcode 15 displayed at a retail store mobile computer display 30 attached to a shopping cart 14. The retail store mobile computer display 30 may include an LCD linked to the personal computing device 12. The shopper can place the personal computing device 12 in a pocket, purse, or other location within a distance permitting a pairing to be maintained.

At step 504, the shopper places items 11 such as groceries in the cart 14. The cart may include sensors/scanners 33 so that grocery data is captured and sent to customer phone in the shopper's pocket. Here, the store mobile computing device 34 includes a scanning device 33 for scanning a barcode, QR code, or other an identifying marker on the groceries 11.

At step 506, data regarding the scanned items 11 is output to and processed by the store customer personal computing device 12, for example, compared to a shopping list stored electronically at the personal computing device 12 and/or added to a list of items already scanned at the shopping cart 14 to keep track of a current total. The store customer personal computing device 12 can track the scanned item 11 so that the item 11 is added to a list of items to be purchased at a point of sale system 16 (step 508).

At step 510, the retail store mobile computer display 30 receives from the personal computing device 12 via the hands-free shopping application processing system 20 a notification that the scanned item 11 in the shopping cart 14 has been identified, and added to a list of items known to be in the shopping cart 14. The display 23, e.g., LCD, of the retail store mobile computer display 30 can display from the received notification information on the items 11 in the shopping cart 16, a current total price of the items 11, coupon or discount information, and so on.

FIG. 6 is a block diagram illustrating flow paths between elements of a hands-free scanning system, in accordance with some embodiments. Although store-supplied mobile computing device 34 is shown and described in FIG. 6, a retail store mobile computer display 30 may equally apply. Therefore, some or all of the method may include the store-supplied mobile computing device 34 and/or the retail store mobile computer display 30.

At step 602, a store customer personal computing device 12 is linked with a retail store mobile computer display 30, by performing a linking technique similar to or the same as that described with respect to embodiments illustrated in FIGS. 1-5, for example, scanning a barcode 15 or the like on the store-supplied mobile computing device 34. After these electronic devices are linked, or otherwise establish an electronic connection for seamlessly exchanging data between then, the store customer may store the store customer personal computing device 12 away, since there is no need to use it during a shopping experience. Although step 602 is shown as being at a store entrance area, operations in some embodiments may occur elsewhere. If the store customer fails to establish this electronic connection and proceeds to use the store-supplied mobile computing device 34 in an illicit manner, for example, committing fraud by pretending to purchase items, then the security system 17 may receive a signal indicating that no such electronic pairing has been formed, and a security procedure may be executed, e.g., store authorities notified and so on.

At step 604, the customer may shop for items 11 using the store-supplied mobile computing device 34 (and/or the retail store mobile computer display 30 shown in FIGS. 1 and 5). The store-supplied mobile computing device 34 and personal computing device 12 may exchange data with each other and/or with a store computer 16, shopping application processing system 20, and/or other remote computers, databases, or the like in a similar manner as described in the embodiments with respect to FIGS. 1-5.

At step 606, there is no need to have a store clerk or associate at the store exit checking receipts or otherwise confirming item purchases. Although step 606 is shown as being at a store entrance area, operations in some embodiments may occur elsewhere obviate the need for a checkout register. The system allows the customer to walk out of the store but will advise for the customer to pay for the groceries before leaving the store. The security system 17 is configured to send data to the customer smartphone 12 which in turn directs the data to the store device 34 for display, which advises the customer when the customer is approaching the exit area.

If the customer does not pay or check out using the store-provide display device 34, the screen will prompt and advise the customer of what they are doing is illegal and the system will proceed to call the necessary authorities, facilitated via the security system 17.

For example, the security system 17 can generate an alarm at a security office located at the store and if it is severe will also notify the police, for example, determined by a stored threshold that establishes a dollar amount, item size, or other related factors. This system therefore not only provides the customers with an ease of shopping experience but will also provide the stores with a sense of security over their products and quality of the products.

The system and method described herein is not limited to the abovementioned applications. For example, an electronic shelf label (ESL) system or the like that electronically displays a product promotion, or other information such as store advertisements, coupons, or discounts mentioned in other embodiments herein, to a store customer pursuant to information entered by the retailer at the merchandise information source may communicate with a system that includes the electronically paired store-supplied mobile computing device 34 and personal computing device 12. In some embodiments, scanning device 21 of a store customer personal computing device 12 may scan a barcode, QR code, or other indicator displayed by the ESL, and perform a commercial function related to a purchase of an item corresponding to the scanned indicator. In some embodiments, the store customer personal computing device 12 and store-supplied mobile computing device 34 are electronically paired, where the scanning device of the store-provided mobile device 34 scans a barcode, QR code, or other indicator on the ESL, and the personal computing device 12 is relied on for its computer processor to engage with the ESL server and/or other store computer to perform a commercial function related to a purchase or other operation. A rolling inventory, list, or tabulation of the contents of the customer's shopping cart, together with the electronically-recorded customer transactions that ensue from promotional prompts or captured data from the ESL can be stored, maintained, and retrieved from the data storage of the personal computing device 12. Such data can also or in addition be uploaded into network storage facilities hosted within the retailer's computer network.

Another example application may include the use of the electronically paired personal mobile computing device 12 and the retail store mobile computing device 34 for crowdsourcing or related online community, for example, where data exchanged from the electronic pairing may be provided to a crowdsourcing system for use by others. In other embodiments, a crowdsourcing system in turn may contribute to the functionality of the computing device 12 by augmenting data received via the electronic pairing and/or processing power of the computing device 12.

In some embodiments, a transfer of functions between the store-provided mobile device 34 and the personal computing device 12 may occur when one of the devices 12, 34 experiences low battery or power conditions. For example, the retail store mobile computing device 34 may automatically terminate an electronic pairing so that scanning operations are transferred to the camera or other sensor of the personal computing device when the battery of the retail store mobile computing device 34 falls below a predetermined threshold.

As described herein, some or all of the system and method in accordance with some embodiments implemented in a computer system. The computer system may generally comprise a processor, an input device coupled to the processor, an output device coupled to the processor, and memory devices coupled to the processor via a bus or other signal-carrying connector. The processor may perform computations and control the functions of a computer, including executing instructions included in computer code for the tools and programs capable of implementing a method in the manner prescribed by the embodiments of FIGS. 1-6 using a system described in FIGS. 1-6, wherein the instructions of the computer code may be executed by processor via memory device. The computer code may include software or program instructions that may implement one or more algorithms for implementing the systems and methods, as described in detail above. The processor may execute the computer code.

A memory device may include input data. The input data includes any inputs required by the computer code. The output device may display output from the computer code. The memory device may be used as a computer usable storage medium (or program storage device) having a computer readable program embodied therein and/or having other data stored therein, wherein the computer readable program comprises the computer code. Generally, a computer program product (or, alternatively, an article of manufacture) of the computer system may comprise said computer usable storage medium (or said program storage device).

Memory devices include any known computer readable storage medium, including those described in detail below. In one embodiment, cache memory elements of memory devices may provide temporary storage of at least some program code in order to reduce the number of times code must be retrieved from bulk storage while instructions of the computer code are executed. Moreover, similar to processor, memory device may reside at a single physical location, including one or more types of data storage, or be distributed across a plurality of physical systems in various forms. Further, memory device can include data distributed across, for example, a local area network (LAN) or a wide area network (WAN). Further, memory device may include an operating system (not shown) and may include other systems not shown.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to embodiments of the present inventive concepts. Thus, an embodiment of the present invention discloses a process for supporting computer infrastructure, where the process includes providing at least one support service for at least one of integrating, hosting, maintaining and deploying computer-readable code in a computer system including one or more processor(s), wherein the processor(s) carry out instructions contained in the computer code causing the computer system to allow an employment and operation of embodiments of the present invention. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method according to embodiments herein. Thus, the present invention discloses a process for supporting, deploying and/or integrating computer infrastructure, integrating, hosting, maintaining, and deploying computer-readable code into the computer system, wherein the code in combination with the computer system is capable of performing a method according to embodiments, for example, herein.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A hands-free scanning system, comprising:
a shopping application stored at and executed by a personal mobile computing device, the application configured to perform a commercial function related to a purchase at a retail store;
a retail store mobile computing device including a display screen, wherein the personal mobile computing device and the retail store mobile computing device form an electronic pairing for exchanging data therebetween in order to perform the commercial function, wherein the retail store mobile computing device performs a scanning operation as a first operation of the commercial function, and the shopping application facilitates a communication with a store computer system as a second operation of the commercial function in response to the first operation; and
the store computer system that exchanges data with the personal mobile computing device for performing the commercial function, wherein the retail store mobile computing device displays a result of the commercial function in response to the retail store mobile computing device receiving the exchanged data and outputting the result from the exchanged data via the electronic pairing.

2. The system of claim 1, wherein the retail store mobile computing device is coupled to or integrated with a shopping cart or basket.

3. The system of claim 1, further comprising at least one sensor that detects when store items are placed in the shopping cart or basket, and the shopping application tracks via the electronic pairing the presence of the items in the shopping cart or basket for automatically performing a point of sale operation.

4. The system of claim 1, wherein the display screen of the retail store mobile computer displays an identifying marker, and wherein the electronic pairing is formed in response to the personal mobile computing device scanning and processing the identifying marker.

5. The system of claim 4, wherein the identifying marker includes a quick response (QR) code.

6. The system of claim 1, further comprising a media sharing technology to form the electronic pairing.

7. The system of claim 6, wherein the media sharing technology includes a Bluetooth™ interface.

8. The system of claim 1, wherein the second operation of the commercial function includes at least one of generating a shopping list, selecting items for purchase at the store, retrieving data regarding items of interest, and purchasing the items.

9. The system of claim 1, wherein the second operation of the commercial function includes a processing of store advertisements, coupons, or discounts, wherein the first operation performed by the retail store mobile computing device includes a scan operation of the store advertisements, coupons, or discounts, and in response, the personal mobile computing device application outputs a result of the scan operation to the store computer system for processing.

10. The system of claim 1, wherein the electronic pairing is performed at the beginning of the shopping process, the retail store mobile computing device initiates the commercial function after the electronic pairing, and the personal mobile computing device application tracks activity of the retail store mobile computing device when performing the commercial function.

11. The system of claim 1, wherein the personal mobile computing device application is used to control shopping functions performed electronically, including point of sale operations performed at the end of a shopping activity, in response to the commercial function performed by the retail store mobile computing device.

12. The system of claim 1, wherein after the pairing, the electronic pairing permits the shopper to pay for store items from the retail store mobile computing device.

13. The system of claim 1, wherein the store device performs a point of sale (POS) function from the shopping cart.

14. The system of claim 1, wherein the scanning system communicates with a store security system to generate an alarm if the customer attempts to leave the store without paying for the items retrieved as part of the commercial function.

15. The system of claim 1, wherein the pairing is an active pairing or a passive pairing.

16. The system of claim 15, wherein the active pairing occurs when the customer's mobile device is used in the store to perform a scanning operation when away from the shopping cart.

17. The system of claim 15, wherein the passive pairing occurs when the mobile device is placed in the customer's pocket after initial connection and used for communicating with a peripheral device at the shopping cart which performs the scanning.

18. The system of claim 1, wherein the customer mobile computing device includes a battery that outputs a voltage that is less when paired with the store device than when performing the commercial function in the absence of the pairing.

19. An electronic display that links with an application stored at and executed by a personal mobile computing device for scanning products at a shopping cart and tracking the scanned products at the personal mobile computing device, wherein a store customer uses the electronic display to complete a purchase of the scanned products via the linked personal mobile computing device with a remote point of sale (POS) system.

20. A method for shopping, comprising:
forming an electronic pairing between a personal mobile computing device and a retail store computing device;
performing, by the retail store computing device, a peripheral operation during a shopping experience; and
facilitating, by the personal mobile computing device via the electronic pairing, an exchange of a result produced during the peripheral operation from the retail store computing device and a remote store computer.
